(19) United States
(12) Patent Application Publication
(10) Pub. No.: US 2022/0400681 A1
(43) Pub. Date: Dec. 22, 2022

(54) Method for Coating a Facial Mask

(71) Applicant: Serville Waterman, Brooklyn, NY (US)

(72) Inventor: Serville Waterman, Brooklyn, NY (US)

(21) Appl. No.: 17/354,372

(22) Filed: Jun. 22, 2021

(51) Int. Cl. A01N 55/02; A01N 31/02; A01N 25/34; B05D 5/00

(52) U.S. Cl. CPC A01N 55/02; A01N 31/02; A01N 25/34; B05D 5/00

(57) ABSTRACT

A, a method of coating a facial mask is disclosed: providing a container; adding chlorophyll in a range of 1000 mg to 5000 mg into the container; providing organic glycerin to the chlorophyll to form a first mixture; providing salt to the first mixture to form a second mixture; providing a plurality of natural stabilizers to the second mixture to form a third mixture with a certain viscosity based on a facial mask; providing drying agents to the third mixture to form a fourth mixture; providing water to the fourth mixture to form a fifth mixture; providing sodium copper to the fifth mixture to form a sixth mixture; providing isotonic water to the sixth mixture to form a seventh mixture; providing alfalfa to the seventh mixture to form an eighth mixture; providing kosher vegetable glycerin to the eighth mixture to form a ninth mixture; providing the facial mask to be soaked in the ninth mixture for a plurality of hours; drying the facial mask for at least an hour to form a coating on the facial mask; placing the coated facial mask over a face a person wherein the person breathes in Oxygen; and activating the chlorophyll and the organic glycerin when the person breathes out CO2 through the facial mask to prevent a virus from infecting the person.

### FIELD OF THE INVENTION

The present invention relates to a method for coating a facial mask. More particularly, this invention provides a process for coating a facial mask.

### BACKGROUND OF THE INVENTION

In this new Covid-19 rampant society, the thought of being exposed to this new everchanging virus has been met with the overwhelming fear of being contaminated. Everyone's lives are now consumed with the constant cycle of mandated face protection and sanitizer as the new normal since 2020s' outbreak.

Generally, the public wants to use the traditional standard face mask over the thicker N95 mask to protect against Covid-19, because the standard makes breathing easier but it does not provide an adequate protection against Covid-19 it is not an ideal option, whereas N95 or equivalent reusable fabric mask, has the additional drawback of inhibiting the levels of oxygen saturation in the body over prolonged daily use.

Therefore, there is a need for a facial mask that will provide adequate protection against Covid-19 and makes breathing easier.

### SUMMARY OF THE INVENTION

The present invention has been accomplished in view of the above-mentioned technical background, and it is an object of the present invention to provide a method for coating a facial mask.

In a preferred embodiment of the invention, a method of coating a facial mask is disclosed: providing a container; adding chlorophyll in a range of 1000 mg to 5000 mg into the container; providing organic glycerin to the chlorophyll to form a first mixture; providing salt to the first mixture to form a second mixture; providing a plurality of natural stabilizers to the second mixture to form a third mixture with a certain viscosity based on a facial mask; providing drying agents to the third mixture to form a fourth mixture; providing water to the fourth mixture to form a fifth mixture; providing sodium copper to the fifth mixture to form a sixth mixture; providing isotonic water to the sixth mixture to form a seventh mixture; providing alfalfa to the seventh mixture to form an eighth mixture; providing kosher vegetable glycerin to the eighth mixture to form a ninth mixture; providing the facial mask to be soaked in the ninth mixture for a plurality of hours; drying the facial mask for at least an hour to form a coating on the facial mask; placing the coated facial mask over a face a person wherein the person breathes in Oxygen; and activating the chlorophyll and the organic glycerin when the person breathes out CO2 through the facial mask to prevent a virus from infecting the person.

### BRIEF DESCRIPTION OF THE DRAWINGS

These and other advantages of the present invention will become more apparent as the following description is read in conjunction with the accompanying drawings, wherein:

FIG. 1 is a graphical representation of a 1-hour study of an untreated basic mask, a N95 mask and infused/coated mask Formulation 1 & 2 of measured Oxygen Saturation in the body during physical activity;

FIG. 2 is a graphical representation of a 6-month study of an untreated basic mask, a N95 mask, an infused/coated mask Formulation 1 & 2 of potency and shelf stability during dormant cycle;

FIG. 3 is a graphical representation of a 4-hour study of an untreated basic mask, a N95 mask, Formulation 1 & 2 Effectiveness and resistant measured potency to Covid-19 during wear; and

FIG. 4 is a flow chart of a method of making a protective coating of a facial mask in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

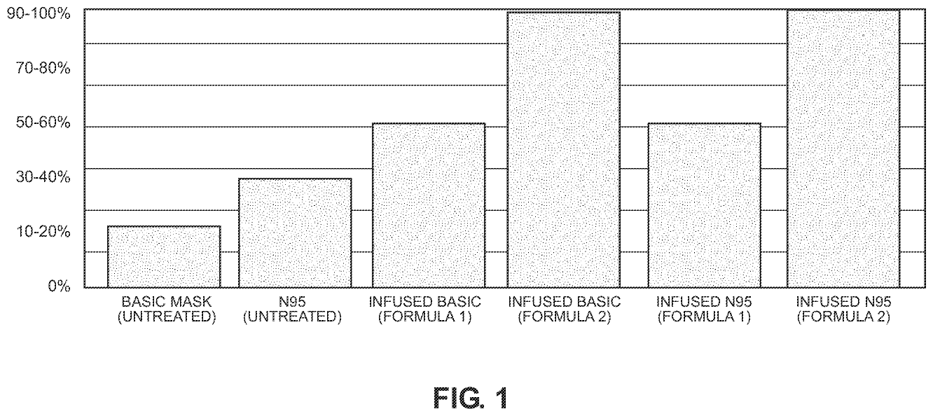

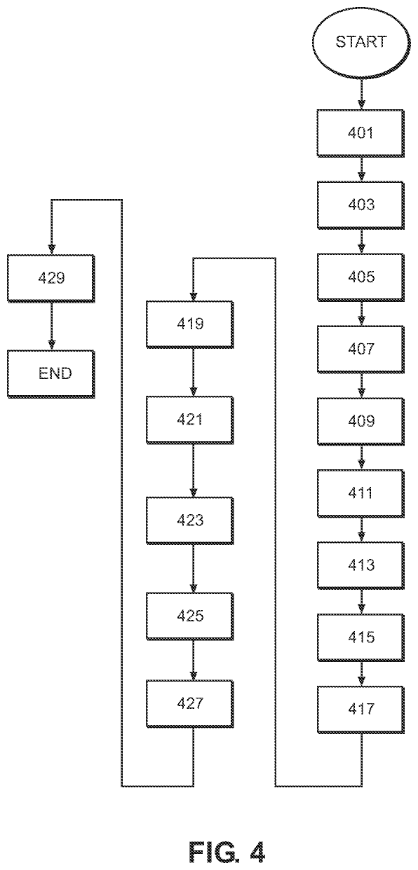

FIG. 1 is a graphical representation of a 1-hour study of untreated basic, N95 and infused mask Formulation 1 & 2 of measured Oxygen Saturation in the body during physical activity. In a 1-hour study an oxygenator was used to measure oxygen saturation of a plain mask and N95 mask, where the basic mask had an oxygen saturation of 30-40% and the N95 mask had an oxygen saturation of 10-20%. When the basic mask is infused with a Formula 1 the oxygen saturation is raised to 70-80% and the Formula 2 the oxygen saturation is raised to 90-100%. Formula 1 is the process disclosed in flow-chart of FIG. 4 where the salt is Kosher salt. Formula 2 is the process disclosed in flow-chart of FIG. 4 where the salt is Iodine or Ionize salt. For the N95 mask is infused with a Formula 1 the oxygen saturation is raised to 50-60% and the Formula 2 the oxygen saturation is raised to 90-100%.

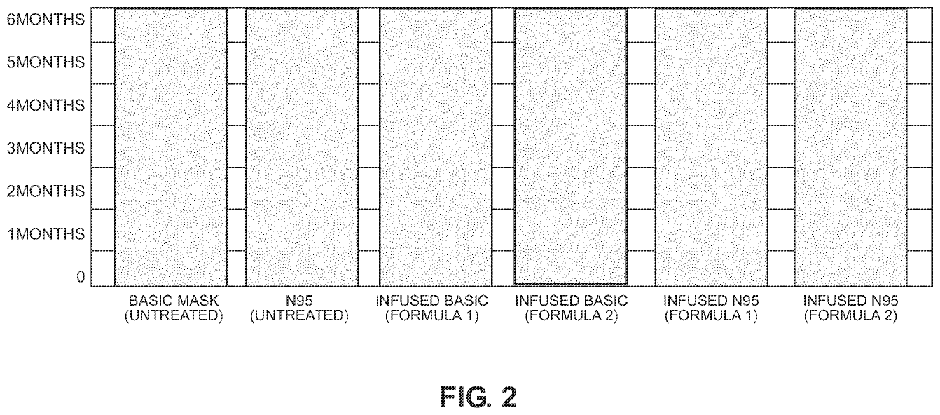

FIG. 2 is a graphical representation of a 6-month study of untreated basic mask, N95, infused mask Formulation 1 & 2 of potency and shelf stability during dormant cycle. The potency and shelf stability during dormant cycle was good for 6 months.

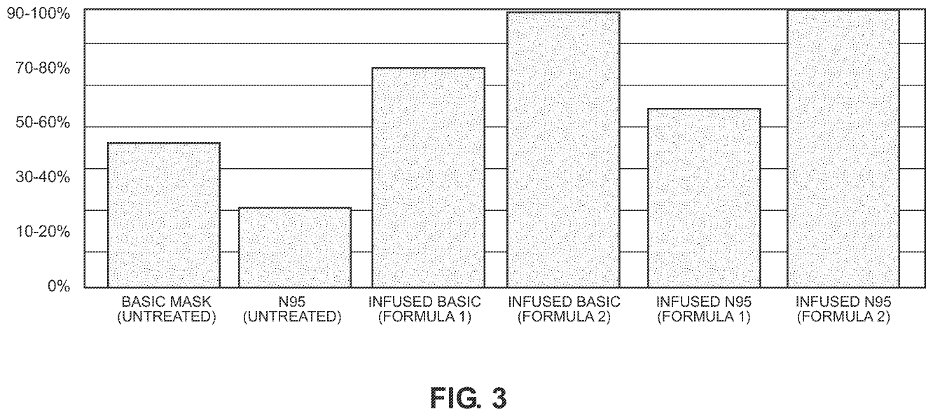

FIG. 3 is a graphical representation of a 4-hour study of an untreated basic mask, a N95 mask, Formulation 1 & 2 effectiveness and resistant measured potency to Covid-19 during wear. For the untreated basic mask, the resistant measured potency is 10-20% for the for 4-hour study. For the N95 untreated mask, the resistant measured potency is 30-40% for the 4-hour study. In a 4-hour study an oxygenator was used to measure oxygen saturation of a plain mask and N95 mask, where the basic mask had an oxygen saturation of 30-40% and the N95 mask had an oxygen saturation of 10-20%. When the basic mask is infused with a Formula 1 the oxygen saturation is raised to 70-80% and the Formula 2 the oxygen saturation is raised to 90-100%. For the N95 mask is infused with a Formula 1 the oxygen saturation is raised to 50-60% and the Formula 2 the oxygen saturation is raised to 90-100%.

FIG. 4 is a flow chart of a method of coating a facial mask in accordance with the invention. At block 401, a basin or container is provided. Next, at block 403, chlorophyll is added in a range of 1000 mg to 5000 mg into the container. Next, at block 405, organic glycerin is added to the chlorophyll to form a first mixture. Next, at block 407 salt is provided to the first mixture to form a second mixture. The salt can be a Kosher salt for Formula 1 or Iodine or Ionized salt for Formula 2. Next, at block 409, a plurality of natural stabilizers is provided to the second mixture to form a third mixture with a certain viscosity based on a facial mask. Next, at block 411 drying agents are provided to the third mixture to form a fourth mixture. Next, at block 413 water is provided to the fourth mixture to make the fifth mixture. Next, at block 415 providing sodium copper to the fifth mixture to form a sixth mixture. At block 417, providing isotonic water to the sixth mixture to form a seventh mixture. Next, at block 419 providing alfalfa to the seventh mixture to form an eighth mixture. Next, at block 421 providing kosher vegetable glycerin to the eighth mixture to a ninth mixture. Next, at block 423 providing a facial mask to be soaked in the ninth mixture for a plurality of hours. At block 425, the facial mask dries for at least at an hour to form a coated facial mask. Next, at block 427 the coated facial mask is placed over a face a person where the person breathes in Oxygen. Lastly, at block 429 the chlorophyll and the organic glycerin are activated when the person breathes out CO2 through the facial mask to prevent a virus from infecting the person and this process ends. The virus may be any type of infectious disease such as Covid-19. The potency of this coated mask works up to 6 months to prevent a person from being infected with Covid-19.

This invention provides a simple to coat a facial mask. This coated facial mask provides a simple added level of protection against Covid19. This coating of the facial mask is a simple non cost prohibitive to protect a person from Covid19 infection.

Although the present invention has been described above in terms of specific embodiments, many modifications and variations of this invention can be made as will be obvious to those of ordinary skill in the art, without departing from its spirit and scope as set forth in the following claims.

What is claimed is:

1. A method of coating a facial mask comprising:
providing a container;
adding chlorophyll in a range of 1000 mg to 5000 mg into the container;
providing organic glycerin to the chlorophyll to form a first mixture;
providing salt to the first mixture to form a second mixture;
providing a plurality of natural stabilizers to the second mixture to form a third mixture with a certain viscosity based on a facial mask;
providing drying agents to the third mixture to form a fourth mixture;
providing water to the fourth mixture to form a fifth mixture;
providing sodium copper to the fifth mixture to form a sixth mixture;
providing isotonic water to the sixth mixture to form a seventh mixture;
providing alfalfa to the seventh mixture to form an eighth mixture;
providing kosher vegetable glycerin to the eighth mixture to form a ninth mixture;
providing the facial mask to be soaked in the ninth mixture for a plurality of hours;
drying the facial mask for at least an hour to form a coating on the facial mask;
placing the coated facial mask over a face a person wherein the person breathes in Oxygen; and
activating the chlorophyll and the organic glycerin when the person breathes out CO2 through the facial mask to prevent a virus from infecting the person.

2. The method of coating a facial mask of claim 1, wherein the facial mask is a plain facial mask.

3. The method of coating a facial mask of claim 1, wherein the facial mask is a N95 mask.

4. The method of coating a facial mask of claim 1, wherein the salt is Kosher salt

5. The method of coating a facial mask of claim 1, wherein the salt is an Iodine salt.
